(19) United States
(12) Patent Application Publication
(10) Pub. No.: US 2003/0223623 A1
(43) Pub. Date: Dec. 4, 2003

(54) Face-recognition using half-face images

(76) Inventors: Srinivas Gutta, Yorktown Heights, NY (US); Miroslav Trajkovic, Ossining, NY (US); Vasanth Philomin, Hopewell Junction, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/161,068

(22) Filed: Jun. 3, 2002

(51) Int. Cl. G06K 9/00

(52) U.S. Cl. 382/118

(57) ABSTRACT

Left and right half-face images are processed as independent components in a face-recognition algorithm. To provide compatibility with full-face image recognition systems, mirror-images of the half-face images are used to create full-face images corresponding to each of the left and right half-face images. Each of the created full-face images is compared to a reference full-face image, using conventional face-recognition algorithms. By comparing each of the left-based image and right-based image, the system overcomes the recognition problems that are caused by directional or non-uniform illumination. Alternatively, a composite full-face image can be created based on a blending of the characteristics of each of the left and right half-face images, thereby filtering the illumination variations.

### BACKGROUND OF THE INVENTION

1. Field of the Invention

This invention relates to the field of computer vision, and in particular to recognition systems based on facial characteristics.

2. Description of Related Art

Face recognition is commonly used for security purposes. In a manual security system, security badges containing facial photographs are used to control access to secured areas or secured material. In automated and semi-automated systems, face recognition software is used to similarly match a current image of a person, from, for example, a video camera, with a stored image. In conventional systems, the user identifies himself or herself, and the face recognition software compares the video image with one or more stored images of the identified person.

Face recognition is also used in a variety of other applications as well. Copending U.S. patent application, “DEVICE CONTROL VIA IMAGE-BASED RECOGNITION”, Ser. No. 09/685,683, filed Oct. 10, 2000 for Miroslav Trajkovic, Yong Yan, Antonio Colmenarez, and Srinivas Gutta, Attorney Docket US000269, incorporated by reference herein, discloses the automated control of consumer appliances, based on a facial recognition of a user, and preferences associated with the recognized user.

U.S. Pat. No. 5,956,482, “MULTIMEDIA INFORMATION SERVICE ACCESS” issued Sep. 21, 1999 to Agraharam et al, and incorporated by reference herein, presents a security technique wherein a user requests access to an information service, the system takes a video snapshot of the user, and grants access to the information service only if the snapshot corresponds to an authorized user. U.S. Pat. No. 5,835,616, “FACE DETECTION USING TEMPLATES”, issued Nov. 10, 1998 to Lobo et al, and incorporated by reference herein, presents a two step process for automatically finding a human face in a digitized image, and for confirming the existence of the face by examining facial features. The system of Lobo et al is particularly well suited for finding one or more faces within a camera's field of view, even though the view may not correspond to a typical facial snapshot.

A common problem with face recognition algorithms is varying illumination levels. As a person travels from one area to another, the person's face is typically illuminated from different directions. As the illumination level and direction of a current facial image differs from the illumination level and direction of the reference facial image that is used to identify the person, the ability of the system to recognize the person degrades. A shadowed cheek, for example, can be misinterpreted as a beard, because the ability to distinguish color is substantially reduced in dark images. In like manner, strong lighting can diminish features and details that would normally be apparent due to shading.

### BRIEF SUMMARY OF THE INVENTION

It is an object of this invention to improve the effectiveness of facial recognition algorithms. It is a further object of this invention to reduce the variations in an image caused by variations in illumination level and direction.

These objects and others are achieved by processing the left and right half-face images as independent components in a face-recognition algorithm. To provide compatibility with full-face image recognition systems, mirror-images of the half-face images are used to create full-face images corresponding to each of the left and right half-face images. Each of the created fall-face images is compared to the reference full-face image, using conventional face-recognition algorithms. By comparing each of the left-based image and right-based image, the system overcomes the recognition problems that are caused by directional or non-uniform illumination. Alternatively, a composite full-face image can be created based on a blending of the characteristics of each of the left and right half-face images, thereby filtering the illumination variations.

### BRIEF DESCRIPTION OF THE DRAWINGS

The invention is explained in further detail, and by way of example, with reference to the accompanying drawings wherein:

FIG. 1 illustrates an example block diagram of a face-recognition system in accordance with this invention.

FIG. 2 illustrates an example flow diagram of a face-recognition system in accordance with this invention.

FIG. 3 illustrates an example flow diagram for composing faces in a face-recognition system in accordance with this invention.

Throughout the drawings, the same reference numerals indicate similar or corresponding features or functions.

### DETAILED DESCRIPTION OF THE INVENTION

This invention is premised on the observation that, except in abnormal situations, a person's face is left-right symmetric. As such, a full-face image contains redundant information. Alternatively stated, a half-face image can be used to create a full-face image, or, the two halves of a full-face image can be used to form a composite full-face image based on a blending of the symmetrically redundant information. Copending U.S. patent application “System and Method of Face Recognition through ½ Faces”, Ser. No. 09/966436 filed Sep. 28, 2001 for Srinivas Gutta, Miroslav Trajkovic, and Vasanth Philomin, Attorney docket US010471, discloses an image classifier that can be trained to learn on half-face or full-face images, and is incorporated by reference herein.

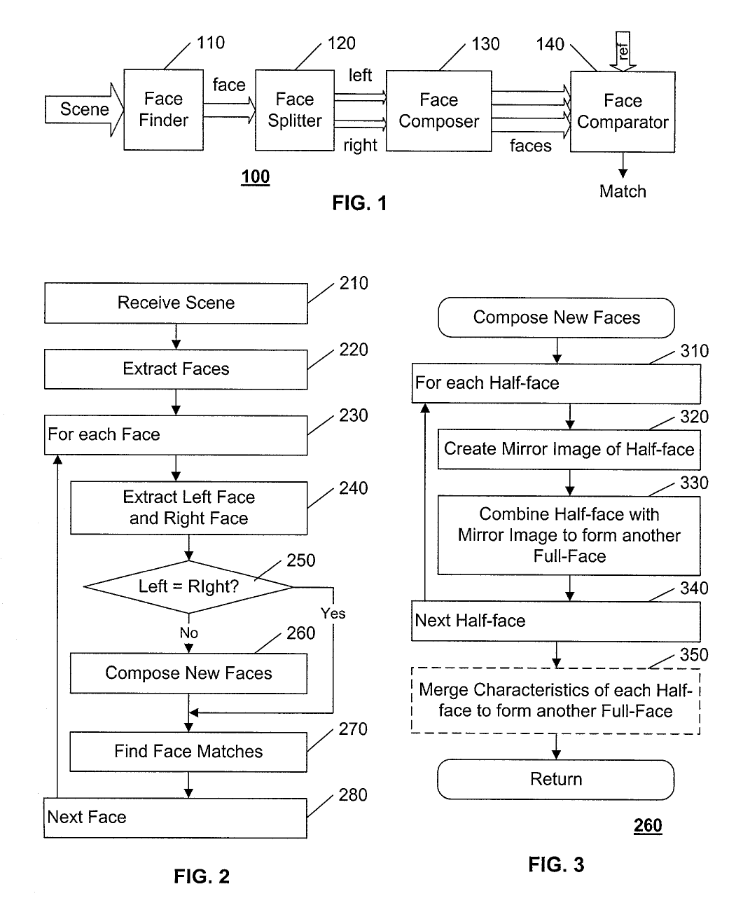

FIG. 1 illustrates an example block diagram of a face-recognition system 100 in accordance with this invention. A face-finder 110 is configured to recognize faces within an image, using techniques common in the art. Typically, for example, faces are recognized by finding local areas of flesh tones, with darker areas corresponding to eyes. At 120, each located face is processed to provide two half-faces.

In a preferred embodiment, the face in the image is “warped” (translated, rotated, and projected) to form a facial image that is substantially “full-faced”, and this full-faced image is split in half to form a left and right half-face image. Assuming that both eyes are visible in the image, the full-faced image is produced by projecting a line between the eye-corners in the image, and translating and rotating the image such that the line is horizontal, and lies on a plane that is parallel to the image plane. Thereafter, left and right half-face images are produced by bisecting this plane at the midpoint of the line between the eye-corners. Other techniques for partitioning a face image into two half-face images will be evident to one of ordinary skill in the art. Similarly, techniques for extracting a single half-face image, when, for example, the face image is in profile, will also be evident to one of ordinary skill in the art.

A face-composer 130 is configured to create one or more full-face images based on the half-face images provided by the face-splitter 120. In a preferred embodiment, as discussed further below, each half-face image is used to create a full-face image, by combining the half-face image with its mirror image. Except in abnormal circumstances, differences between two opposing half-face images are generally indicative of different illumination on each side of the face image. Because the illumination in most environments is directional, if the half-face images differ, it is usually because one side of the face is properly illuminated, and the other half is not. Thus, the two created full-face images are likely to include one properly illuminated full-face image that can be compared to a reference image, via a conventional face-comparator 140. Even if neither half-face image is properly illuminated, the created full-face images will be, by creation, symmetrically illuminated, and therefore more likely to match a symmetrically illuminated reference image.

Techniques may be employed to select which of the two created full-face images is more properly illuminated, and compare the more properly illuminated image to the reference image. In a preferred embodiment, however, the selection process is eliminated in preference to comparing both created full-face images to the reference image, because the processing time required to compare the two created images with each other is likely to be comparable to the processing time required to compare each of the created images with the reference image.

Other techniques may be employed to create full-face images from the extracted half-face images. For example, in another preferred embodiment, the aforementioned two created full-face images are merged to form another full-face image. The merging may be based on a simple averaging of pixel values within each image, or it may be based on more sophisticated techniques, such as those used for ‘morphing’ images in conventional image processing systems.

The face-comparator 140 uses conventional face comparison techniques, such as those presented in the patents referenced in the background of the invention. Note that this invention is particularly well suited as an independent “add-on” process to a conventional face comparison system. The blocks 110-130 merely present the original and the created images to the face comparator 140 as separate images for comparison with the reference face image.

FIG. 2 illustrates an example flow diagram of a face-recognition system in accordance with this invention. At 210, a scene image is received, from which one or more faces are extracted, at 220. Not illustrated, the extracted face images may be processed or composed based on a plurality of image scenes, using techniques common in the art to highlight features, reduce noise, and so on. Each face image is processed via the loop 230-280 to provide alternative faces that are each compared to one or more reference faces, at 270.

At 240, each full-face image is processed to extract a left-face and a right-face image. If the face extraction process of 220 does not provide a full-face image, the process 240 performs the necessary translation and rotation processes to provide a full-face image, as discussed above. If both the left and right face are substantially equivalent, then the created new faces based on these equivalent halves will generally be substantially equivalent to the original full-face image. To avoid the needless creation of equivalent new faces, the face composition block 260 is bypassed when, at 250, the two half-face images are determined to be substantially equivalent. Any of a variety of techniques may be used to determine equivalence between the half-face images. In a preferred embodiment, a sum-of-squares difference measure is used to determine the magnitude of the differences between each half-image.

An example face composition process 260 is detailed in FIG. 3. Each half-face image is processed via the loop 310-340. At 320, a mirror image of the half-face image is created, and this mirror image is combined with the half-face image to produce a full-face image, at 330. Note that if the extraction process 240 of FIG. 2 only produces one half-face image, such as when the face image is in profile, the process 260 provides at least one full-face image for comparison with the reference image, via this mirror-and-combine process 320-330. If the extraction process 240 of FIG. 2 provides both half-face images, two full-face images are produced. Optionally, as discussed above, other full-face images may be produced based on a merging of select characteristics of each of the half-face images, at 350.

Returning to FIG. 2, each of the created images, and optionally the original image, is compared to one or more reference images, at 270, to identify a potential match. Because each of the created images represent, effectively, the same face at different illuminations, the process of this invention increases the likelihood of properly identifying a face even when the illumination level and/or direction is not uniform or consistent.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the invention is presented in the context of processing half-faces to form a variety of fall-faces for comparison with a reference full-face image. Alternatively, the reference face image may be stored as a half-face image, and the aforementioned processing and comparisons may be relative to the half-face reference image, consistent with the techniques disclosed in copending U.S. patent application Ser. No. 09/966436, referenced above. That is, in this alternative embodiment, each half-face image or its mirror is compared directly with the half-face reference image. Additionally, a composite half-face that is based on characteristics of both of the half-face images can be compared to the half-face reference image. These and other system configuration and optimization features will be evident to one of ordinary skill in the art in view of this disclosure, and are included within the scope of the following claims.

I claim:

1. A face recognition system comprising:
a face-splitter that is configured to extract one or two half-face images from a face image, and
a face-composer, operably coupled to the face-splitter, that is configured to provide one or more comparison images to a face-comparator, based on at least one of the one or two half-face images.

2. The face recognition system of claim 1, further including
a face-finder, operably coupled to the face-splitter, that is configured to extract the face image from a scene image.

3. The face recognition system of claim 1, further including
the face-comparator, which is configured to compare the one or more comparison images to one or more reference images.

4. The face recognition system of claim 3, wherein
the one or more reference images correspond to half-face reference images, and
the face-comparator is configured to mirror at least one of the one or more reference images and the one or more comparison images to effect a comparison.

5. The face recognition system of claim 1, wherein
the face-splitter is further configured to warp an input face image to provide the face image as a full-face image that is parallel to an image plane that is used by the face-splitter to extract the one or two half-face images.

6. The face recognition system of claim 4, wherein
the face-splitter warps the input face based on a line that is projected between eye-corners in the input face image.

7. The face recognition system of claim 1, wherein
the face-composer creates the one or more comparison images by combining a mirror-image of each of the one or two half-images with each of the one or more half-images.

8. The face recognition system of claim 1, wherein
the face-composer creates the one or more comparison images by combining characteristics of each of the one or more half-images.

9. A method of preprocessing a face image for use in a face recognition system, the method comprising:
extracting at least one half-face image from the face image,
providing one or more comparison images to the face recognition system, based on the at least one half-face image.

10. The method of claim 9, wherein
the face recognition system is configured to compare full-face images, and
providing the one or more comparison images includes
combining a mirror image of the at least one half-face image to the at least one half-face image.

11. The method of claim 9, wherein
the at least one half-face image includes a left-face image and a right-face image, and
providing the one or more comparison images includes
merging characteristics of each of the left-face and right-face images.

12. The method of claim 11, wherein
the face recognition system is configured to compare half-face images.

13. The method of claim 9, further including:
translating and rotating an input image to provide the face image.

14. The method of claim 13, wherein
the translating and rotating of the input image is based on a line that is projected between eye-corners in the input image.

15. A computer program that, when executed on a computer system, is configured to cause the computer system to:
extract at least one half-face image from a face image, and
provide at least one comparison image based on the at least one half-face image for comparison with one or more reference images.

16. The computer program of claim 15, which is further configured to cause the computer system to
compare the at least one comparison image to the one or more reference images.

17. The computer program of claim 15, which is further configured to cause the computer system to
translate and rotate an input image to provide the face image.

18. The computer program of claim 15, which is further configured to cause the computer system to provide the at least one comparison image by:
creating a mirror image of the at least one half-face image, and
combining the mirror image to the at least one half-face image to form the at least one comparison image.

19. The computer program of claim 15, wherein
the at least one half-face image includes a left-face image and a right-face image, and
the computer program is further configured to cause the computer system to provide the at least one comparison image by
combining characteristics of each of the left-face and right-face images to form the at least one comparison image.
